(19) United States
(12) Patent Application Publication
(10) Pub. No.: US 2026/0057301 A1
(43) Pub. Date: Feb. 26, 2026

(54) INTEGRATED CIRCUIT WITH FINE TUNING MODEL PARAMETERS FOR NOISY MEMORY CANCELLATION

(71) Applicant: Taalas Inc., Toronto (CA)

(72) Inventor: Ljubisa Bajic, Toronto (CA)

(21) Appl. No.: 19/308,869

(22) Filed: Aug. 25, 2025

Related U.S. Application Data
(60) Provisional application No. 63/686,732, filed on Aug. 24, 2024.

(51) Int. Cl. G06N 20/00; G06F 15/80

(52) U.S. Cl. CPC G06N 20/00; G06F 15/80

(57) ABSTRACT

Methods and systems that involve computing architectures with large machine learning models stored in dense memories are disclosed herein. A disclosed method includes adding a machine learning model to a computing architecture, where the machine learning model was trained on the computing architecture after being added to the computing architecture, and the machine learning model is stored in at least one memory on the computing architecture. The disclosed method also includes fine-tuning the machine learning model to counteract a decrease in performance of the machine learning model on the computing architecture that is attributable to the at least one memory. The fine-tuning may include training the machine learning model on the computing architecture.

### CROSS REFERENCE TO RELATED APPLICATION

This application claims the benefit of U.S. Provisional Patent Application No. 63/686,732, titled “Integrated Circuit with Fine Tuning Model Parameters for Noisy Memory Cancellation,” and filed on Aug. 24, 2024, the entire content of which is incorporated by reference herein.

### TECHNICAL FIELD

This disclosure relates to computational architectures, in particular, to utilizing hardware implemented pointers to store and modify large data structures.

### BACKGROUND

The past years have seen rapid advancements in specialized computing architectures for applications such as cryptography, cloud computing, machine learning, and other applications. While these computing architectures continue to advance in terms of their ability to parallelize complex computations and execute specific computations more efficiently, the computational requirements of these applications continue to grow at a more rapid pace. This trend has led to a substantial increase in the computational resources required by these applications. Large machine learning models exemplify this trend, particularly large language models such as GPT-3, which have over 150 billion trainable parameters. Even larger models, including hundreds of billions of trainable parameters, are already in deployment.

Training large machine learning models necessitates substantial computational resources, leveraging vast and powerful computer systems composed of thousands of graphics processing units (GPUs) or specialized accelerators. These systems, typically deployed in high-performance data centers, are interconnected to handle the immense volumes of data and complex calculations involved. Once trained, the models can be used for generating inferences (e.g., classifying inputs, making predictions, generating control signals, or generating text). While model-based inference systems are generally less complex than those used to train the models, the models, comprising billions or even trillions of parameters, still require extensive memory capacity for storage. As a result, both training and deploying large machine learning models pose substantial technical and resource-intensive challenges.

### SUMMARY

Disclosed herein are methods and systems involving customized computing architectures, where large machine learning models is stored in dense memories. Certain computerized memory devices capable of efficiently storing data, such as the parameters of a large language model, have been developed at extreme densities. However, these memory devices are often subject to noise sources, which distort the true value that is intended to be written to and read from the memory cells of the memory devices. For example, incorrect bits may be read from multi-bit valued memory cells, as noise sources can impact the manner in which a write/program circuit puts a value into a memory cell, the manner in which the value is stored in the cell over time, or the manner in which a read circuit reads the value from the cell.

Using the approaches disclosed herein, a single computing architecture can store the parameters of a large machine learning model in dense but noisy memory while maintaining the performance of the machine learning model by fine-tuning the machine learning model to counteract the impact of those noise sources. The large machine learning model can be first trained on a system with abundant computational resources (e.g., a large server network) and then added to a computing architecture with fewer computational resources (e.g., as a multicore processor). The computing architecture can store the machine learning model in dense memory and refine the machine learning model to offset the performance degradation of the machine learning model caused by memory noise. This fine-tuning requires much less computational effort than initial training. As such, modest systems in terms of their available resources can be used to store extremely large machine learning models and generate accurate inferences therefrom without a network connection to an external computing architecture.

The machine learning model can be a large parameter machine learning model, such as a GPT model, LAMA, BERT, or ViT-22B. The computing architecture can include a model core that stores the parameters defining the model in a memory. The computing architecture can also include an inference engine that is configured to execute the computations necessary to draw an inference from the model. The performance of a machine learning model can be quantified using metrics, such as a level of accuracy in generating inference on an industry-standard dataset or a widely-adopted benchmark task set, to evaluate and compare machine learning models. The noise sources of the memory on the computing architecture can degrade this performance. Such degradation is attributable to the memory itself, as the model, when executed on the computing architecture and using the inference engine to draw inference, fails to meet its expected performance level.

In some embodiments, the machine learning model can be fine-tuned on the computing architecture by training the machine learning model on the computing architecture. This training can mitigate the decrease in performance of the machine learning model on the computing architecture that is attributable to the memory of the computing architecture. The fine-tuning of the machine learning model can thereby effectively cancel out the impact of the noisy memory of the computing architecture on the machine learning model. As a result, the machine learning model can be deployed on the computing architecture and stored in extremely high-density memory without incurring a loss in performance of the machine learning model.

In some embodiments, a computing architecture, such as an application specific integrated circuit (ASIC) or multicore processor, can be designed to have a machine learning model added to the computing architecture, store the machine learning model in high density memory, and then fine-tune the machine learning model to cancel out the impact of the high-density memory on the performance of the machine learning model. The same ASIC or multicore processor design (e.g., a single design) can be used to make sets of parts that are optimized for different large machine learning models. This can be achieved by storing a given model in the high-density memory of the parts in each set, and each individual part within a given set can use the approaches disclosed herein to refine the machine learning model and counteract the noise sources of the individual part on that given model. In some embodiments, both the storage and refinement of the machine learning model may be performed during back-end of line processing or during final test and assembly of the parts, providing flexibility and manufacturing efficiency.

In some embodiments, a method disclosed herein includes adding a machine learning model to a computing architecture, where the machine learning model is trained on the computing architecture after being added to the computing architecture, and the machine learning model is stored in a first memory set on the computing architecture. The method also includes fine-tuning the machine learning model to counteract performance degradation of the machine learning model on the computing architecture that is attributable to the first memory set. In some embodiments, the computing architecture includes at least one integrated circuit, and the first memory set includes a read only memory on the integrated circuit. In some embodiments, the first memory set includes a multibit memory having a set of cells that each stores a multibit value, and the performance degradation of the machine learning model on the computing architecture is attributable to a set of noise sources in the first memory set.

In some embodiments, the adding of the machine learning model to the computing architecture includes storing the machine learning model in the first memory set, the fine-tuning of the machine learning model includes training the machine learning model on the computing architecture without modifying the machine learning model stored in the first memory set, and the training of the machine learning model includes determining a set of fine-tuning parameters. In some embodiments, the set of fine-tuning parameters forms a low rank adaptation adapter for the machine learning model. In other embodiments, the set of fine-tuning parameters replaces a corresponding set of parameters of the machine learning model.

In some embodiments, the method includes storing the set of fine-tuning parameters in a second memory set. Each of the first and second memory sets may include one or more memories. The first memory set includes read only memory, and the second memory set includes random access memory, where the first memory set is denser than the second memory set. In some embodiments, the adding of the machine learning model to the computing architecture includes fabricating the at least one integrated circuit of the computing architecture such that the machine learning model is programmed in the first memory set, and the storing of the set of fine-tuning parameters in the second memory set includes writing the set of fine-tuning parameters in the second memory set. In some embodiments, the first memory set includes mask read only memory, and the second memory set includes electrically programmable read only memory. In other embodiments, the method includes storing the set of fine-tuning parameters in the first memory set.

In some embodiments, the method includes running an automated training routine for the fine-tuning of the machine learning model, where the automated training routine is instantiated in hardware on the computing architecture. In some embodiments, the method includes applying unique labeled inputs to the machine learning model one or more times to produce one or more outputs using the automated training routine, where a loss function of the automated training routine accepts the multiple outputs as batched inputs.

In some embodiments, a computing architecture disclosed herein includes a hard-wired model core configured to store a machine learning model and a programmed fine-tuning portion configured to store a set of fine-tuning parameters. The programmed fine-tuning portion stores a set of fine-tuning parameters for a fine-tuned machine learning model, which is a fine-tuned version of the machine learning model. The fine-tuning portion counteracts performance degradation of the machine learning model on the computing architecture that is attributable to the hard-wired model core. In some embodiments, the hard-wired model core includes a mask read only memory that stores the set of parameters of the machine learning model, and the programmed fine-tuning includes a programmable read only memory that stores the set of fine-tuning parameters for the machine learning model. In some embodiments, the computing architecture is a multicore processor.

In some embodiments, a computing architecture disclosed herein includes a first memory set, a second memory set, and an inference engine. The first memory set is configured to store a machine learning model with a set of parameters. The second memory set is configured to store a set of fine-tuning parameters for a fine-tuned machine learning model, where the fine-tuned machine learning model is a fine-tuned version of the machine learning model that has been fine-tuned to counteract performance degradation of the machine learning model on the computing architecture that is attributable to the first memory set. The inference engine is configured to generate an inference from the fine-tuned machine learning model using the set of fine-tuning parameters. In some embodiments, the inference engine uses the set of parameters and the set of fine-tuning parameters to generate the inference from the fine-tuned version of the machine learning model.

In some embodiments, the first memory set includes mask read only memory, and the second memory set includes an electrically programmable read only memory. In some embodiments, the set of fine-tuning values forms a low rank adaptation adapter for the machine learning model. In other embodiments, the set of fine-tuning values replaces a corresponding set of parameters of the machine learning model in the fine-tuned version of the machine learning model. In some embodiments, the computing architecture is a multicore processor.

In some embodiments, a computing architecture disclosed herein includes a machine learning model, a fine-tuned portion, an inference engine, and an automated training routine. The machine learning model is stored in at least one memory. The fine-tuning portion, for the machine learning model, is stored on the computing architecture. The fine-tuning portion counteracts a decrease in performance of the machine learning model on the computing architecture that is attributable to the at least one memory. The inference engine is configured to generate inferences from the machine learning model combined with the fine-tuning portion. The automated training routine is stored on the computing architecture, where the fine-tuning portion is generated by the automated training routine using the machine learning model and the inference engine.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The disclosed embodiments have advantages and features that will be more readily apparent from the detailed description, the appended claims, and the accompanying figures (or drawings). A brief introduction of the figures is below.

FIG. 1 (FIG. 1) illustrates an exemplary computing architecture, according to some embodiments.

FIG. 2 illustrates various options for how an inference engine can use a model core and a fine-tuning portion to generate an inference, according to some embodiments.

FIG. 3 illustrates a flow chart for a set of methods for providing a computing architecture, according to some embodiments.

FIG. 4 illustrates a read only memory (ROM) array memory cell, according to some embodiments.

FIG. 5 illustrates a random access memory (RAM) array memory cell in which the memory cell includes a loop of inverters, according to some embodiments.

FIG. 6 illustrates an exemplary multi-value RAM memory cell, according to some embodiments.

### DETAILED DESCRIPTION

The Figures (Figs.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Methods and systems that involve computing architectures in accordance with the summary above are disclosed in detail herein. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or some embodiments thereof, may or may not fall within the ambit of another, or some embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

The computing architectures disclosed herein for storing machine learning models (e.g., storing the parameters defining the machine learning models) can take various forms in different embodiments. Generally, these computing architectures have fewer computing resources as compared to an external system on which the machine learning model was trained. The computing architectures may include a standard von Neumann computing architecture with a memory and a central processing unit or other execution area. Alternatively, the computing architectures may have less conventional designs, such as systolic arrays, compute-in-memory architectures, or other configurations. The computing architectures may also include accelerators, such as GPUs, tensor processing units (TPUs), neural processing units (NPUs), etc., that are used to support a central processing unit. In some embodiments, the computing architectures can themselves function as accelerators, assisting central processing units (CPUs) by generating inferences from a machine learning model. The computing architectures can be implemented using field programmable gate arrays (FPGAs), ASICs, integrated circuits, wafer scale integrated circuits, networks of processing cores, multicore processors, etc.

The machine learning models can be stored in the memory of the computing architectures disclosed herein in various ways. In some embodiments, the machine learning models can be stored in one or more discrete memories. For example, in a multicore processor, the machine learning model can be stored in a shared memory accessible by all cores, or in different discrete memories on each of the cores in the multicore processor. When one or more discrete memories are used, a set of parameters that define a machine learning model can be stored as values in the memory cells of the memory, with a total number of parameters split amongst the one or more discrete memories. The memory can be hard-wired read only memory (ROM), mask ROM, programmable read only memory (PROM), or electrically programmable read only memory (EPROM). The memory can also be static random-access memory (SRAM), dynamic random-access memory (DRAM), flash memory, high bandwidth memory (HBM), or other memory.

In some embodiments, the machine learning model can be stored in one or more memories, while the fine-tuning parameters used to form a refined machine learning model can be stored in separate one or more memories. For example, the machine learning model may be stored in hard coded ROM (e.g., mask ROM), while the fine-tuning parameters may be stored in EPROM. As used in this disclosure, the terms “machine learning model,” “base model,” or “model core” may be used interchangeably. As used in this disclosure, the one or more memories used to store the parameters that define the machine learning model can be referred to as a first memory set, and the one or more memories used to store the fine-tuning parameters can be referred to as a second memory set. In some embodiments, the same memory may be used to store both the base model parameters (i.e., the set of parameters that define the machine learning model) and the fine-tuning parameters.

In some embodiments, the machine learning model is trained externally and is then added to the computing architecture. Training the machine learning model externally can include setting the parameters of the machine learning model using a machine learning training routine. It is known that training a complex machine learning model can require a massive network of interconnected servers and millions of dollars in operating costs. Once the parameters have been set and the machine learning model has been trained, the model can be incorporated into a computing architecture in various ways, such as by adding the parameters to a model core of the computing architecture.

In some embodiments, the parameters of the machine learning model can be added to the computing architecture by being programmed into ROM during fabrication of the devices that form the computing architecture. For example, the parameters can be stored in a hard-wired model core in the form of mask ROM that is programmed with the parameter values during fabrication. The ROM may be programmed through the controlled introduction of dopants to specific transistors that form the ROM. The ROM may also be programmed during back end of line processing by altering a pattern of metal wires that connect different ROM nodes. Other methods for programming ROM during device fabrication may likewise be used to store the parameters of the machine learning model.

In other embodiments, the parameters of the machine learning model can be added to the computing architecture after the devices that form the computing architecture are fabricated. The parameters may be programmed into PROM or EPROM post-fabrication during final test, packaging, or assembly of the devices. The PROM may be programmed through the rupturing or fusing of fuse or antifuse memory, by configuring the state of a mesh through burning or otherwise programming codes into switches such as multiplexers, or by altering the conductivity or connectivity state of multibit memory storage elements. The EPROM may be programmed by applying electrical signals to the memory cells of the memory.

In yet other embodiments, the parameters of the machine learning model can be added to the computing architecture by being written into memory, such as EPROM or RAM after the devices that form the computing architecture have been finally packaged and assembled. In this case, the parameters of the machine learning model may be written into RAM that forms a model core of the computing architecture, or programmed into EPROM through the introduction of electrical signals to the memory cells of the memory.

In some embodiments, the one or more memories on which the machine learning model parameters are stored can be extremely dense memories capable of storing more than 5 terabits per square inch (Tbpsi), such as multibit memories where each cell of the memories can store more than one bit of data. The memories can be noisy memories, causing the degradation of the performance of the machine learning model because the parameters of the machine learning model (i.e., original model parameters) may not be recalled properly from the memories. The noise sources can either impact the original values of the parameters as they are stored in the memory, modify the values of the parameters as they are read from memory, or both. The noisy memories can cause the values in each cell to appear time-variant from the perspective of the overall system, and result in the values stored in each cell being different from the value of the parameter from the machine learning model. Accordingly, the machine learning model may suffer performance degradation attributable to the one or more memories, in that the accuracy or quality of the output of the machine learning model, when executed on the computing architecture using the noisy memories, fails to match the accuracy or quality of the output of the machine learning model when the model is run on a computing architecture without a noisy memory (e.g., the external computing architecture on which the machine learning model was trained).

In some embodiments, the machine learning model can be fine-tuned on the computing architecture to counteract the performance degradation that is attributable to the nosey memories. The fine-tuning may include obtaining a set of fine-tuning parameters that replace or augment the parameters of the machine learning model. The combination of the machine learning model and the fine-tuning parameters can form a fine-tuned version of the machine learning model. The computing architecture can include an automated training routine in order to determine the fine-tuning parameters. The automated training routine can utilize an inference engine of the computing architecture and training data that is supplied from an external source. The training data can be the same data that was used to train the original machine learning model, and the automated training routine can be similar to the process used to train the original machine learning model. However, the fine-tuning parameter set can be much smaller than the original model parameter set, making the training routine in fine-tuning far less computationally intensive. In some embodiments, the automated training routine can be designed to repeatedly apply the same instances of training data (e.g., an input and a labeled output forming a supervised training data pair) to the machine learning model, in order to characterize and correct for memory noise statistics (e.g., to train for the mean and standard deviation of the noise sources of the memory when the parameters are time variant values).

In some embodiments, the fine-tuning parameters of the fine-tuned version of the machine learning model can be stored in the same memory (e.g., first memory) as the parameters of the machine learning model or original model parameters. In other embodiments, when a ROM memory, which is programmed through fabrication or otherwise programmed before the device, is operational, the fine-tuning parameters can be stored in a different memory (e.g., second memory) than the parameters of the machine learning model. In other words, the first memory and the second memory can be different. In some embodiments, the second memory used to store the fine-tuning parameters can be less dense and less noisy than the first memory used to store the machine learning model parameters. For example, the first memory may not include error correction circuitry or redundant storage, while the second memory may include error correction circuitry and redundant storage. The number of parameters in the fine-tuning portion can be between 10⁶ and 10⁹ times smaller than the number of the original model parameters, such that the usage of a less dense memory for storage of the fine-tuning parameters can be less burdensome in terms of resource utilization.

In some embodiments, the automated training routine can be instantiated in hardware on a device. In some embodiments, the automated training routine can use the same inference engine that is subsequently used by the computing architecture to generate inferences from the refined version of the machine learning model. The automated training routine can be stored in ROM on the device and utilize hard-coded logic to determine the fine-tuning parameters for the machine learning model as the machine learning model is added to the computing architecture.

In some embodiments, the automated training routine can operate opaquely to a user or designer of the computing architecture to automatically cancel out the impact of the noisy memory on the computing architecture. Accordingly, all or a portion of the entire process can be conducted automatically without input from either a user or designer of the computing architecture, where the process includes obtaining the machine learning model, running the training routine to determine the fine-tuning parameters, storing the fine-tuning parameters to memory, and using the refined version of the machine learning model in place of the machine learning model for future inferences run by the computing architecture. Alternatively or additionally, the computing architecture can also be designed to automatically modify the machine learning model with the fine-tuning parameters once the fine-tuning parameters have been stored in memory.

In some embodiments, the fine-tuning parameters can be found and stored by fine-tuning circuitry in the computing architecture. The fine-tuning circuitry can store the parameters generated during the training routine, where the routine is used to fine-tune the machine learning model to counteract the impact of the noisy memory. The fine-tuning circuitry can store the parameters that are generated by a parameter-efficient fine-tuning (PEFT) routine for the model, and may also be configured to execute the computations necessary for the PEFT routine and/or to execute the computations necessary to draw an inference from the fine-tuned model.

The model core may be less configurable than the fine-tuning portion. The model core can be fixed before the fine-tuning portion is fixed. In some embodiments, the model core can be a hardwired model core. The model core can be implemented in a portion of the computing architecture that is fixed at the time the computing architecture is fabricated and finalized for deployment. Fixing the characteristics of a portion of a computing architecture can be conducted in various ways, such as by setting the values in a read only memory or a programmable read only memory. As used herein, the term “fabricated” refers to the point/stage in a manufacturing process when the computer chip(s) (e.g., silicon substrates) of the computing architecture are being operated upon in a fabrication plant, and “final test and customization” refers to the point in a manufacturing process when the PROM of the computing architecture is being programmed and/or the firmware of the computing architecture, if any, is loaded into the computing architecture.

The fine-tuning portion can be more configurable than the hardwired model core and may be fixed after the model core is fixed. In some embodiments, the fine-tuning portion is a programmable fine-tuning portion. For example, the fine-tuning portion can be programmed at the time the computing architecture is deployed and operational, allowing its characteristics to be set by a user who is operating the computing architecture. The model core can be fixed at the time the device is fabricated and when the computing architecture is undergoing final customization before it is shipped to that user. As another example, the fine-tuning portion can be programmed at the time the computing architecture is undergoing final customization before being sent to a customer, and the model core can have its characteristics fixed at the time the computing architecture is fabricated.

In some embodiments, the parameters produced by a PEFT routine and stored by the fine-tuning portion may render some of the parameters in the model core superfluous or redundant. However, the computing architecture can be configured to ignore or discard the superfluous parameters when rendering an inference from the fine-tuned model. While these superfluous parameters represent wasted memory consumption of the model core when the computing architecture generates the inference, the resource overheads attributable to the superfluous parameters are relatively minor due to the significantly lower space and power consumption of less configurable circuitry. Furthermore, the number of parameters required to fine-tune the model is far less than the overall number of parameters of the machine learning model. As such, the computing architecture can store a very large machine learning model in an extremely small area while achieving performance comparable to that of a much more expensive computing architecture.

### System Implementation

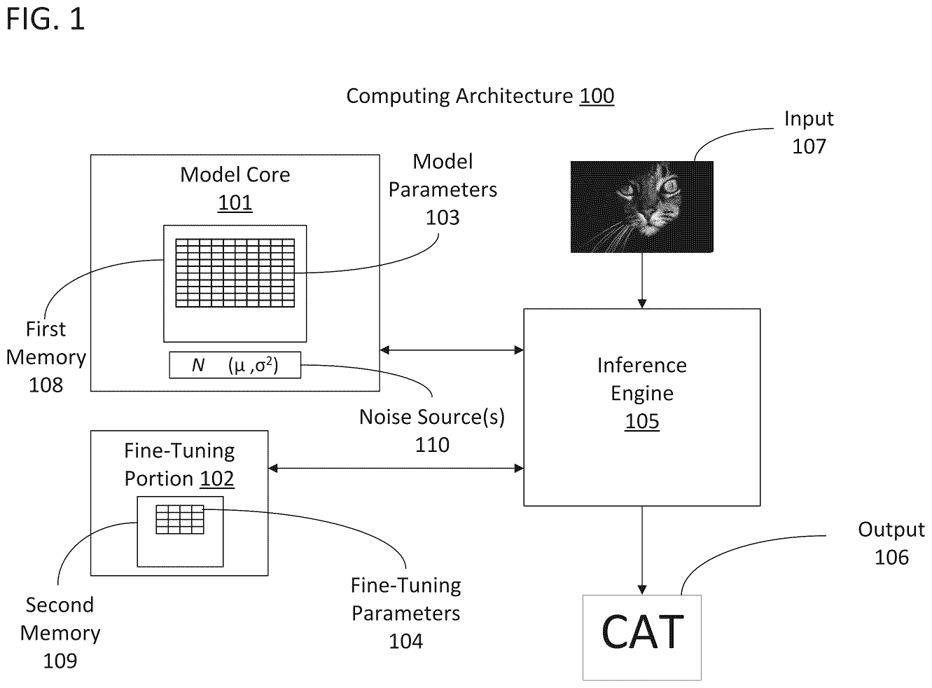

FIG. 1 illustrates an exemplary computing architecture 100, according to some embodiments. The computing architecture 100 can be implemented in various ways. In some embodiments, the computing architecture 100 can be a specialized architecture that is configured to accelerate a particular workload in a given application, such as generating an inference from a machine learning model or generating a hash using a cryptographic algorithm. The computing architecture 100 can be implemented in a data center (e.g., with a set of servers), in an edge environment (e.g., a mobile data center), on a client device (e.g., a mobile phone, a wearable device), or on an internet of things (IoT) device (e.g., a sensor). The computing architecture 100 can also be implemented on a stationary device (e.g., a base station), on a mobile vehicle (e.g., an autonomous automobile), or on a collection of vehicles (e.g., a swarm of autonomous drones).

The computing architecture can be implemented by a single computing node or a collection of computing nodes operating in concert. The computing architecture can be implemented as a single specialized ASIC, a single core processor, a multicore processor, or a network of processors. The computing architecture can be implemented on a single substrate, on multiple substrates in a single package, on multiple packages of a common back plane, on one or more servers, and in one or more data centers. The computing architecture can be implemented on multiple computing nodes (e.g., multiple chiplets) or on one or more wafer-scale integrated circuits.

If the computing architecture is implemented as a collection of computing nodes, the computing architecture may include a network, such as a network on chip (NoC) for a multicore processor. The term NoC is not meant to indicate that all the cores of the processor reside on a single semiconductor substrate. It should be recognized that a NoC can be implemented across various chips that are interconnected. These various chips can be integrated within a single package or housed in separate packages. The various chips can be on different chips and networked together on a common backplane, such as a printed circuit board, interposer, or silicon mesh. Alternatively, the various chips can be mounted on different support structures, such as different printed circuit boards or silicon meshes. The interconnection network linking the computing nodes may span various levels, including a server level, rack level, and inter- and intra-data center levels. The network may also include any form of interconnect mesh, and can scale from intra-chip communication to connections across the Internet.

As depicted in FIG. 1, the computing architecture 200 can include a model core 101 and a fine-tuning portion 102. The fine-tuning portion 102 can be a programmable fine-tuning portion. The model core 101 can store a set of parameters 103 of a machine learning model. The fine-tuning portion 102 can store a set of fine-tuning parameters 104 for a fine-tuned machine learning model. The fine-tuned machine learning model can be a fine-tuned version of the machine learning model. The fine-tuned version of the machine learning model can be defined by the set of parameters 103 of the machine learning model and the set of fine-tuning parameters 104 of the fine-tuned machine learning model.

The computing architecture 100 can also include an inference engine 105. Inference engine 105 can use the model core 101 and fine-tuning portion 102 to generate an inference output 106 from an input 107. For example, as illustrated in FIG. 1, inference engine 105 may generate an output 106 in the form of a class (i.e., “CAT”) for an input image 107. In this case, the model being executed by the inference engine 105 is an image classifier. However, other types of machine learning models could be executed by an inference engine (e.g., inference engine 105). For example, the machine learning model may include large language models (LLMs), natural language processing (NLP) models, variational autoencoders (VAEs), generative adversarial networks (GANs), long short-term memory networks (LSTMs), recurrent neural networks (RNNs), convolutional neural networks (CNNs), transformer models, autoencoders, and any machine learning model that is defined by a large number of parameters. In particular, the machine learning model does not have to be an artificial neural network, since the approaches disclosed herein apply to reinforcement learning models and other types of models. In some embodiments, the inference engine 105 can be replaced with an alternative computational engine for a different workload. The computational engine can use the model core and fine-tuning portion to execute that different workload.

The model core 101 can be fixed during fabrication or during final test and customization of the customized computing architecture 100. The fine-tuning portion 102 can be fixed at a later time than when the model core 101 is fixed. Fixing model core 101 can involve setting the values of the model parameters 103 in a memory of the model core 101. The memory can be a first memory 108, which can be a ROM, a one-time programmable (OTP) PROM, an EPROM, a re-programmable ROM, an EEPROM, or another type of memory. Fixing the fine-tuning portion 102 can involve setting the values of the fine-tuning parameters 104 in a memory of the fine-tuning portion 102. The memory can be a second memory 109, which can be a ROM, an OTP PROM, a PROM, a re-programmable ROM, an EPROM, an EEPROM, a random access memory (RAM), a static random-access memory (SRAM), a dynamic random access memory (DRAM), a flash memory, or another type of memory.

As used herein, the term “fixed” refers to the point at which a circuit module has its parameters locked in such a way that they are set and cannot be changed without reprogramming. For example, a laser fuse PROM is fixed as soon as it is burned in, with the bits either fused or cut. As another example, a mask ROM is fixed as soon as the layers that define the mask ROM have been applied in the process flow of the chip. As another example, an embedded system module is fixed as soon as the firmware has been loaded into the module by programming the non-volatile memory of the module. Throughout this discussion of the embodiments of FIG. 1, an alternative implementation may involve writing values to either the model core 101 or the fine-tuning portion 102 as opposed to fixing the values. As used herein, the term “fabricated” refers to the point in a manufacturing process at which the computer chip(s) (e.g., silicon substrates) of the computing architecture 100 are being operated upon in a fabrication plant, and “final test and customization” refers to the point in a manufacturing process in which the PROM of the computing architecture 100 is being programmed and/or the firmware of the computing architecture 100, if any, is loaded into the computing architecture.

The model core 101 and the fine-tuning portion 102 can be fixed in various ways. For example, the model core 101 can be fixed during fabrication as the top layers of the chip, or chips, on which the model core is being implemented are fabricated. In this example, the model parameters 103 can be stored in mask ROM. The mask ROM can store data by forming different connections between wires, as defined by configurable masks of the fabrication process. The mask ROM can store the data in the form of different transistors that have been activated instead by configurable implant masks of the fabrication process. A model core that is fixed in such a manner cannot be modified after formation, such as in the case of a mask ROM implementation or an OTP implementation, which is referred to herein as a hard-wired model core. The fine-tuning portion 102 can be fixed after the model core is fixed. For example, if the model core 101 is fixed during fabrication, the fine-tuning portion 102 can be fixed during final test and customization. As another example, if the model core 101 is fixed during final test and customization, the fine-tuning portion 102 can be fixed when the computing architecture 100 is deployed and in operation.

In some embodiments, the model core 101 can be less configurable than the fine-tuning portion 102. The model core 101 can be hard-wired and fixed during fabrication of the device, while the fine-tuning portion 102 can be programmable and fixed during final test and customization. A fine-tuning portion that can be fixed after fabrication, such as during OTP programming during final test and customization, is referred to herein as a programmable fine-tuning portion. For example, the model parameters 103 can be stored in mask ROM, and the fine-tuning parameters 104 can be stored in OTP memory, which is written to when the computing architecture 100 is being finalized for delivery to a customer. The set of parameters 103 of the machine learning model can be defined during the fabrication of the computing architecture. The set of fine-tuning parameters 104 for the fine-tuned machine learning model can be defined during programming of the computing architecture.

The model parameters 103 and the fine-tuning parameters 104 can take on various forms. Both sets of parameters can be different data types, such as 8-bit integer, 16-bit floating point, and various other data types. The sets of parameters 103 can be the same data types or different data types. The model parameters 103 can include all the parameters necessary to define a large machine learning model. For example, if the large machine learning model were GPT-3, the model parameters could be all 150 billion parameters plus the parameters that are needed to generate an inference from GPT-3. The fine-tuning parameters 104 can be parameters generated by a PEFT routine operating on the model parameters 103 or some other routines used to produce parameters to fine-tune a model. The fine-tuning parameters 104 can be parameters that counteract the impact of noise sources 110 of the first memory 108 on the performance of the machine learning model described by the set of model parameters 103. The fine-tuning parameters 104 can be smaller in number than the model parameters 103. The fine-tuning parameters 104 can be parameters of a fine-tuned machine learning model. The fine-tuned machine learning model can be a fine-tuned version of the machine learning model. The fine-tuning parameters 104 can be selected to replace specific parameters of the model core or can be selected to augment the parameters of the model core.

In some embodiments, the fine-tuning portion 102 will include data that indicates which parameters are being replaced in the model parameters or how the fine-tuning parameters are meant to be used to augment the model parameters. This data can be stored explicitly (e.g., by an address of a set of parameters in the model parameters that will be replaced by specific tine-tuning parameters) or implicitly (e.g., by storing fine-tuning parameters that are meant to be used to a particular adapter at a location that is expected by the design and integration of fine-tuning portion 102 and inference engine 105).

In some embodiments, the model core 101 and the fine-tuning portion 102 can use different kinds of memories to store parameters. In some embodiments, the model core 101 can store a set of parameters of a machine learning model, such as model parameters 103, in a first memory 108. The fine-tuning portion 104 can store a set of fine-tuning values for a fine-tuned machine learning model, such as fine-tuning parameters 104, in a second memory 109. The first memory 108 can have a higher density than the second memory 109. In particular, the first memory 108 can be a higher density and less configurable memory, while the second memory 109 can be a lower density and more configurable memory. For example, the first memory 108 can be a mask ROM, and the second memory 109 can be a flash EPROM. Accordingly, the base model (e.g., model core 101) can be stored in a high-density memory and a large volume of chips can be produced using the base model, while the fine-tuning portion 102 is modified to adapt the base model for specific use cases. In the example of FIG. 1, the base model 101 can be a general image classifier, and the fine-tuning portion 102 can fine-tune the model to improve its performance in classifying black and white images.

The fine-tuning parameters 104 can be generated in various ways. In some embodiments, the fine-tuning parameters 104 can be generated by a separate architecture that performs a fine-tuning routing for the model parameters 103. The fine-tuning parameters 104 can then be loaded into the computing architecture 100, such as by being programmed into second memory 109 (e.g., by being programmed into a non-volatile flash memory). In other embodiments, the fine-tuning portion 102 can include logic circuitry to perform a fine-tuning routine on the model parameters 103 stored in model core 101. However, given the computational requirements of running standard fine-tuning routines, it will likely be more efficient to run the routines externally and load the fine-tuning parameters into the fine-tuning portion 102, particularly when the computing architecture 100 is implemented as a multicore processor or individual integrated circuit.

The fine-tuning routines can involve adjusting the model core 101 to achieve better performance despite the suboptimal performance of first memory 108. The specific fine-tuning routine can vary based on the architecture of the model core 101, the task(s) conducted by the machine learning model, and the characteristics of the first memory 108. The fine-tuning routine can be a PEFT routine, such as a Low-Rank Adaptation (LoRA) routine. The PEFT routine can identify sets of parameters in the model (e.g., model core 101) that need to be replaced in order to counteract the impact of noise sources 110. The PEFT routine can formulate adapters that work alongside the model to optimize the model for a noise source. The PEFT routing can formulate adapters that replace portions of the model, or the model as a whole, to optimize the model for a particular memory. The PEFT routing can generally produce parameters and any ancillary data required to produce a fine-tuned machine learning model that is a fine-tuned version of the machine learning model associated with the model core 101.

The model core 101 and the fine-tuning portion 102 can be designed in combination with the inference engine 105 to generate inferences from a fine-tuned machine learning model, depending upon the type of fine-tuning routine that is applied. For example, the elements of the computing architecture 100 can be designed to replace portions of the parameters from the model core 101 with parameters from the fine-tuning portion 102. Since the memory in which the model parameters 103 are stored may not be erasable, this could be conducted by modifying an address table used to access the model parameters 103 with addresses for replacement parameters in the fine-tuning portion 102. As another example, the elements of the computing architecture 100 may be configured to modify the instructions executed by the inference engine 105 to include an adapter or substitute portion of the fine-tuned machine learning model when generating an inference from the fine-tuned machine learning model. The inference engine 105 could be designed to execute two different graphs, one for the machine learning model and one for the fine-tuned machine learning model, using stored instructions that define the graphs via an order of operations and the address of the required parameters for those operations.

The elements of the computing architecture 100 may also be configured to render inferences using only the original machine learning model, if no fine-tuning routine was conducted or if it was desired to use the original model at a specific time. A specific status register in the computing architecture 100 may be configured to place the computing architecture 100 in a mode where the fine-tuned version of the model is to be used to generate an inference, or in a mode where the original model is to be used to generate an inference. In other words, the computing architecture 100 can employ a status register to select whether to use the original model or the fine-tuned model for inference generation.

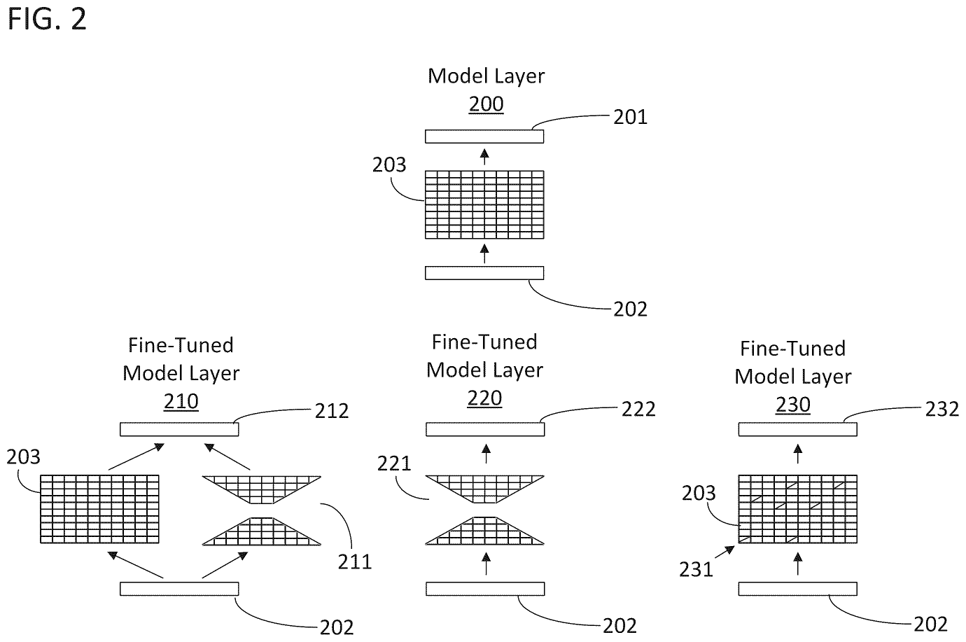

FIG. 2 illustrates various options for how an inference engine (e.g., inference engine 105 in FIG. 1) can use a model core (e.g., model core 101) and a fine-tuning portion (e.g., fine-tuning portion 102) to generate an inference in accordance with some embodiments disclosed herein. Model layer 200 is an illustration of how an input 202 to a machine learning model can be used to generate an output 201 of the layer using a set of model parameters 203 that define the layer. Input 202 can be the output of a prior layer, and output 201 can be the input to the next layer. Variants of the machine learning model from which model layer 200 is taken to form fine-tuned models are described below. The fine-tuning portion of the computing architecture can store fine-tuning parameters to augment or otherwise modify the machine learning model and can alternatively or in combination include logic to modify the machine learning model. For example, the fine-tuning portion can store a set of fine-tuning parameters, and the set of fine-tuning parameters can form a low rank adaptation adapter for the machine learning model, as shown in the examples of fine-tuned model layer 210 and fine-tuned model layer 220 below. Alternatively, or in combination, the fine-tuning portion can store a set of fine-tuning parameters, and the set of fine-tuning parameters can replace a corresponding set of parameters of the machine learning model in the fine-tuned version of the machine learning model, as shown in the example of fine-tuned model layer 230 below.

In some embodiments, the fine-tuned model may include either the whole original machine learning model or a portion thereof, along with an augmentation such as an adapter. Fine-tuned model layer 210 is a layer from such a fine-tuned model. Fine-tuned model layer 210 includes a set of model parameters 203 from the original machine learning model, along with a low rank adapter 211. Fine-tuned model layer 210 accordingly applies the input 202 to both the set of model parameters 203 and the low rank adapter 211, and then combines their respective outputs to produce layer output 212. In this approach, the low rank adapter 211 has far fewer parameters than the set of model parameters 203, such that retraining the model by only modifying the parameters of the low rank adapter 211 is more efficient than retaining the whole model. In embodiments that are in accordance with fine-tuned model layer 210, fine-tuning portion 102 can store the parameters that define the low rank adapter 211. Fine-tuning portion 102 can also store information identifying which layers of the machine learning model should be augmented with the inclusion of an adapter, such as low rank adapter 211. Furthermore, in some embodiments, fine-tuning portion 102 can include logic to execute the computations required to apply input 202 to low rank adapter 211. For example, inference engine 105 may be a hardwired logic system (e.g., a systolic array) configured to execute the machine learning model, and fine-tuning portion 102 can include logic to harvest layer input values (e.g., input 202) and the activations from the application of input 202 to the set of model parameters 203, apply the input to the low rank adapter 211, and formulate the output 212 for the next layer of the model. The logic for modifying the model to produce the fine-tuned model and the corresponding parameter values can be configurable in the fine-tuning portion 102.

In some embodiments, the fine-tuned model may be a simplified replacement to the original model. For example, the simplified replacement can comprise a low rank approximation of the original model. Fine-tuned model layer 220 is a layer from such a fine-tuned model in that it includes a low rank approximation 221 of set of model parameters 203 that can be used to produce layer output 222 from input 202. In this approach, the low rank approximation 221 has far fewer parameters than the set of model parameters 203 such that retraining the model by only modifying the parameters of low rank approximation 221 is more efficient than retaining the whole model. In embodiments that are in accordance with fine-tuned model layer 220, fine-tuning portion 102 can store the parameters that define the low rank approximation 221. Alternatively, fine-tuning portion 102 can store the parameters that define low rank approximation 221 in combination with model core 101. For example, fine-tuning portion 102 can store replacement parameters for the parameters within the set of model parameters 203. Additionally, or in combination, fine-tuning portion 102 can store an identification of parameters from the set of model parameters 203 that should be excluded in forming the low rank approximation 221. Fine-tuning portion 102 can also store information identifying which layers of the machine learning model should be augmented with the use of a low rank approximation 221. Furthermore, in some embodiments, fine-tuning portion 102 can include logic to execute the computations required to apply input 202 to low rank approximation 221. For example, inference engine 105 may be a hardwired logic system (e.g., a systolic array) configured to execute the machine learning model, while the fine-tuning portion 102 can include logic to harvest layer input values (e.g., input 202), apply the input to the low rank approximation 221, and formulate output 222 for the next layer of the model. The logic defining how the model is modified to produce the fine-tuned model, as well as the associated parameter values, can be configurable in the fine-tuning portion 102. While a low rank approximation has been used in this example, low rank approximation 221 can be replaced with any simplified representation of the set of model parameters 203 that can be more efficiently trained than the set of model parameters 203.

In some embodiments, the fine-tuned model may include a set of fine-tuning parameters that replace a corresponding set of parameters of the machine learning model. Fine-tuned model layer 230 is a layer from such a fine-tuned model. Fine-tuned model layer 230 may include a set of fine-tuning parameters 231 (marked by strikes through the corresponding parameters of the machine learning model) of set of model parameters 203 that can be used to produce layer output 232 from input 202. In this approach, the replacement parameters are significantly fewer in number than the parameters in the set of model parameters 203, such that retraining the model by only modifying the replacement parameters is more efficient than retaining the whole model. In embodiments that are in accordance with fine-tuned model layer 230, fine-tuning portion 102 can store the replacement parameters along with an identification of the corresponding parameters in the set of model parameters 203 that are to be replaced. The location of the corresponding parameters can be stored explicitly, such as by identifying an address of the corresponding model parameters with reference to the structure of the set of model parameters 203 or with reference to the addresses of a memory in the model core (e.g., first memory 108) in which the set of model parameters is stored. Alternatively, the locations can be stored implicitly, such as by storing the values in specific locations in second memory 109 or by storing the replacement values in a data structure with the same dimensions as set of parameters 203 such that the data structure can serve as a mask to replace the corresponding values. For example, fine-tuning portion 102 can store replacement parameters for parameters in the set of model parameters 203. One benefit of this approach is that the logic required to execute the fine-tuned model remains similar to that of the logic required to execute the original model, except for the logic used to retrieve the replacement values.

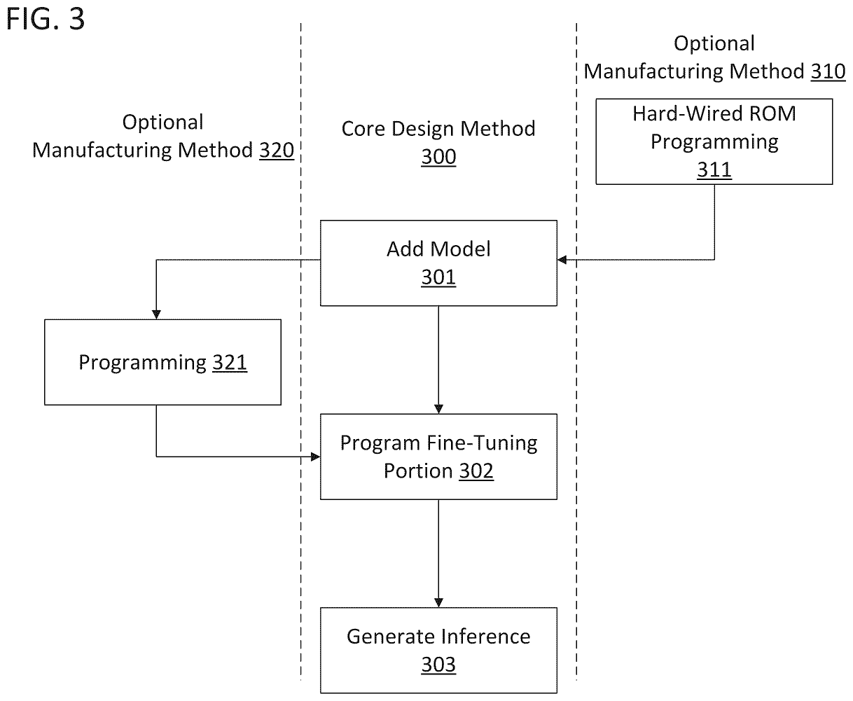

FIG. 3 illustrates a flow chart 300 for a set of methods for providing a computing architecture in accordance with some embodiments disclosed herein. As depicted, FIG. 3 includes a core design method and two optional manufacturing methods. Manufacturing method 320 and manufacturing method 310 are not mutually exclusive.

Core design method 300 includes a step 301 of adding a machine learning model to a computing architecture, whereby a model core stores a set of parameters of the machine learning model in a first memory. The model core can be model core 101. The first memory can be memory 108. Core design method 300 also includes a step 302 of programming a fine-tuning portion of the computing architecture, whereby a programmed fine-tuning portion of the computing architecture is formed. Fine-tuning portion can be fine-tuning portion 102. As a result of steps 301 and 302, the programmed fine-tuning portion can store a set of fine-tuning values for a fine-tuned machine learning model in a second memory. The second memory can be memory 109. The fine-tuned machine learning model can be a fine-tuned version of the machine learning model, and the fine-tuned version of the machine learning model can have improved performance, compared with the machine learning model, when used on the computing architecture. The fine-tuning portion can counteract the impact of the first memory on the performance of the machine learning model. The first memory can have a higher density than the second memory. Core design method 300 can continue with a step 303 of generating an inference using the fine-tuned version of the machine learning model. Step 301 can be conducted by a manufacturer of the computing architecture (e.g., at a fabrication facility for semiconductor chips). Step 303 can be conducted by a user of the computing architecture after the computing architecture has been deployed for use with the fine-tuned version of the machine learning model. Step 302 can either be conducted by the manufacturer of the computing architecture or by the user of the computing architecture, based on which manufacturing method is utilized.

In some embodiments, the optional manufacturing method 320 includes a step 321 of programming the fine-tuning parameters of the computing architecture. Step 321 can be conducted after fabricating the model core in step 301. Using this approach, a manufacturer can both program a computing architecture with a core model and distribute the computing architecture to users, with the noise sources of the memory counteracted. This approach can be beneficial in that the end user will not need to provide training data, run a routine, or even be aware of the fine-tuning.

In some embodiments, the optional manufacturing method 310 includes a step 311 of hard-wire programming the model core of the computing architecture. In these embodiments, the manufacturer can minimize costs of providing customized devices for a given machine learning model in that hard-wired ROM is generally far denser than PROM. At the same time, this approach can be beneficial in that a manufacturer can maintain an inventory of parts having a common core and adapt that same core design for different customers or different customer applications by modifying the specific machine learning model that a given part will utilize.

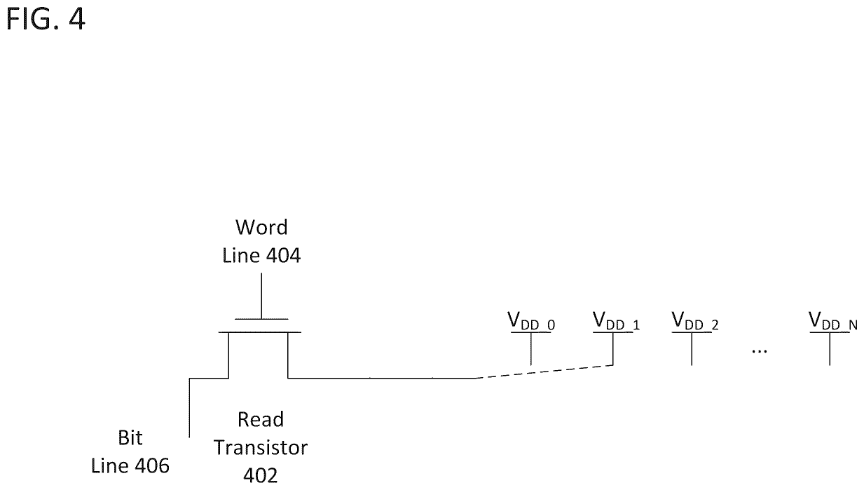

The approaches disclosed herein can be applied to various memory architectures that introduce noise into the data stored therein. The memories can be high-density multibit memories. The memories can have various cell designs, such as those described below with reference to FIGS. 4-6. The memories can be designed to include noise sources; however, these noise sources can be minimized or consolidated such that they can be more easily counteracted by the operation of fine-tuning the parameters of a machine learning model stored therein.

FIG. 4 illustrates a ROM array memory cell, according to some embodiments. The memory cell in FIG. 4 is programmed by connecting the drain of a transistor (e.g., read transistor 402) to different reference voltages (e.g., V_{DD_0}, V_{DD_1}, . . . V_{DD_N}). When reading, a voltage is applied to a word line 404 (e.g., voltage goes high) to turn on the read transistor 402, allowing the capacitance of a bit line 406 to charge up. The resulting voltage on the bit line 406 is measured to determine a stored value in the cell. As such, in approaches such as those illustrated in FIG. 4, the connectivity state of the transistor and the associated value stored thereby can be read definitively using a charge sharing circuit. The idiosyncrasies of the individual storage transistors therefore do not need to be learned by the neural network. In particular, the on-resistance and threshold voltages of the read transistor 402 do not contribute to the voltage to which the capacitor (i.e., the bit line 406) is charged during the charge sharing operation. As such, the variances in those values of parameters from one memory cell to another across the memory array do not need to be learned by neural networks.

In some embodiments, a multi-value memory is provided. The multi-value memory array is a RAM array comprising an array of memory cells, and each memory cell in the array of memory cells comprises a loop of inverters. The RAM array can be integrated with a processor. The processor can conduct computations using a set of logic transistors. The loop of inverters can be formed by a set of inverter transistors. The set of logic transistors and the set of inverter transistors are formed using a common process flow. The multi-value memory can also comprise a decoder neural network configured to receive read values from the memory array, decode the read values into encoded read values, and provide the encoded read values as a denoised output of the multi-value memory. The multi-value memory can also comprise an encoder neural network configured to receive write values for storage in the memory array, encode the write values into encoded write values, and store the encoded write values in the multi-value memory array.

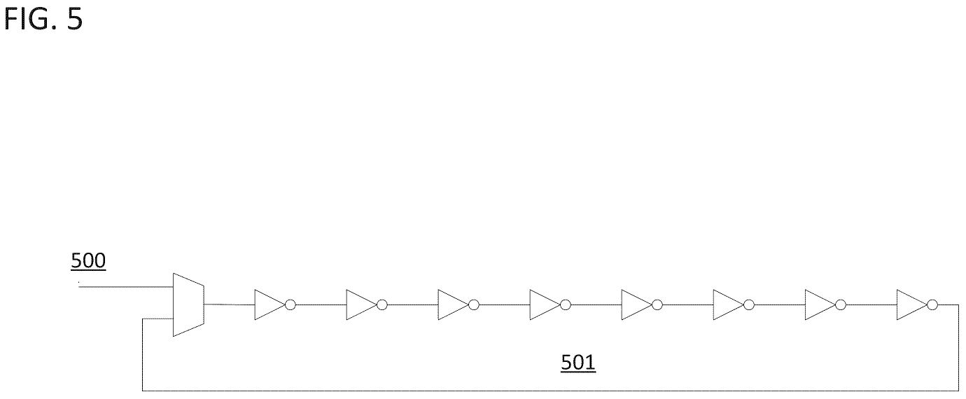

FIG. 5 illustrates a RAM array memory cell in which the memory cell includes a loop of inverters, according to some embodiments. The loop of inverters stores the value of the memory cell in either a pattern of pulses or a pulse width of a pulse that is oscillating through the ring of inverters. The loop of inverters can be programmed by forcing a value on node 500, which will create a pattern of pulses to loop through node 501. The ring of inverters can be formed using transistors fabricated by the same process as the processor transistors for the processor that the RAM array is servicing. As such, the RAM array can be tightly integrated with the processing circuitry of the processor. Furthermore, using an encoder neural network, a decoder neural network, or a combination thereof as described herein, the RAM can be even more tightly integrated, as it will be less susceptible to the noise that would otherwise be generated by an irregular layout for a RAM array. The devices that form the loop of inverters can also be smaller and designed less stringently in terms of their layout when used in combination with such neural networks.

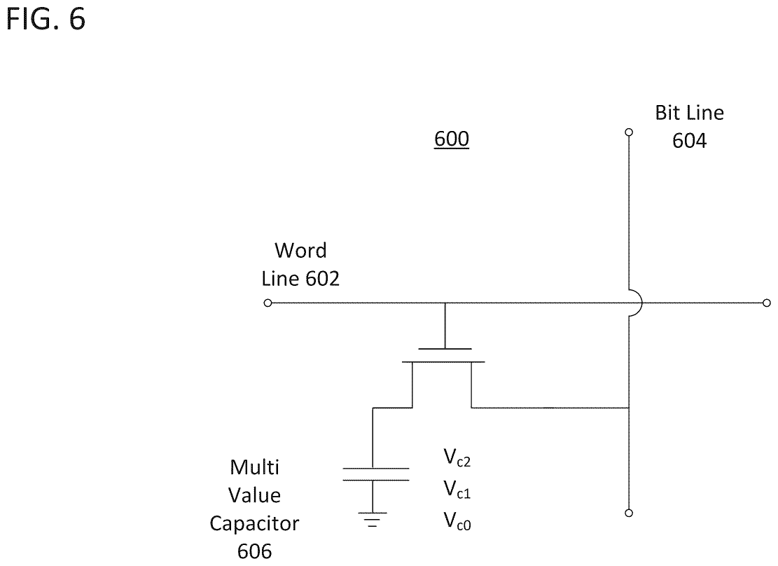

In some embodiments, the noisy memory arrays disclosed herein can be any form of multi-value memory array with storage elements that can store multi-bit values. For example, the storage elements may be multi-bit DRAM cells such as RAM cell 600. As illustrated in FIG. 6, RAM cell 600 includes a single access transistor with its gate connected to a word line 602, source connected to a bit line 604, and drain connected to a storage capacitor 606. RAM cell 600 can be programmed to different values by putting different amounts of charge (e.g., V_{c0}, V_{c1}, V_{c2}, etc.) on the storage capacitor 606. Reading a value from the multi-bit memory cell 600 may then involve sensing the amount of charge that was stored on the capacitor 606 using a read circuit coupled to the bit line 604 when the word line 602 was driven high.

While the specification has been described in detail with respect to some embodiments, it will be appreciated that those skilled in the art, upon attaining an understanding of the foregoing, may readily conceive of alterations to, variations of, and equivalents to these embodiments. Any of the method steps discussed above can be conducted by a processor operating with a computer-readable non-transitory medium storing instructions for those method steps. The computer-readable medium may be memory within a personal user device or a network accessible memory. These and other modifications and variations to the present invention may be practiced by those skilled in the art, without departing from the scope of the present invention, which is more particularly set forth in the appended claims.

What is claimed is:

1. A method comprising:
adding a machine learning model to a computing architecture, wherein the machine learning model is trained on the computing architecture after being added to the computing architecture, and wherein the machine learning model is stored in a first memory set on the computing architecture; and
fine-tuning the machine learning model to counteract performance degradation of the machine learning model on the computing architecture that is attributable to the first memory set.

2. The method of claim 1, wherein:
the computing architecture includes at least one integrated circuit, and
the first memory set includes a read only memory on the integrated circuit.

3. The method of claim 1, wherein:
the first memory set includes a multibit memory having a set of cells,
each cell of the multibit memory stores a multibit value, and
the performance degradation of the machine learning model on the computing architecture is attributable to a set of noise sources in the first memory set.

4. The method of claim 1, wherein:
the adding of the machine learning model to the computing architecture comprises storing the machine learning model in the first memory set,
the fine-tuning of the machine learning model comprises training the machine learning model on the computing architecture without modifying the machine learning model stored in the first memory set, and
the training of the machine learning model comprises determining a set of fine-tuning parameters.

5. The method of claim 4, wherein:
the set of fine-tuning parameters forms a low rank adaptation adapter for the machine learning model.

6. The method of claim 4, wherein:
the set of fine-tuning parameters replaces a corresponding set of parameters of the machine learning model.

7. The method of claim 4, further comprising storing the set of fine-tuning parameters in a second memory set.

8. The method of claim 7, wherein:
the first memory set includes one or more memories, and the one or more memories include read only memory,
the second memory set includes one or more memories, and the one or more memories include random access memory, and
the first memory set is denser than the second memory set.

9. The method of claim 7, wherein:
the adding of the machine learning model to the computing architecture comprises fabricating the at least one integrated circuit of the computing architecture such that the machine learning model is programmed in the first memory set, and
the storing of the set of fine-tuning parameters in the second memory set comprises writing the set of fine-tuning parameters in the second memory set.

10. The method of claim 7, wherein:
the first memory set includes mask read only memory, and
the second memory set includes electrically programmable read only memory.

11. The method of claim 4, further comprising storing the set of fine-tuning parameters in the first memory set.

12. The method of claim 1, further comprising:
running an automated training routine for the fine-tuning of the machine learning model,
wherein the automated training routine is instantiated in hardware on the computing architecture.

13. The method of claim 12, further comprising:
applying unique labeled inputs to the machine learning model one or more times to produce one or more outputs using the automated training routine,
wherein a loss function of the automated training routine accepts the multiple outputs as batched inputs.

14. A computing architecture comprising:
a hard-wired model core configured to store a machine learning model; and
a programmed fine-tuning portion configured to store a set of fine-tuning parameters,
wherein:
(i) the programmed fine-tuning portion stores a set of fine-tuning parameters for a fine-tuned machine learning model,
(ii) the fine-tuned machine learning model is a fine-tuned version of the machine learning model, and
(iii) the fine-tuning portion counteracts performance degradation of the machine learning model on the computing architecture that is attributable to the hard-wired model core.

15. The computing architecture of claim 14, wherein:
the hard-wired model core comprises a mask read only memory that stores the set of parameters of the machine learning model; and
the programmed fine-tuning comprises a programmable read only memory that stores the set of fine-tuning parameters for the machine learning model.

16. The computing architecture of claim 14, wherein:
the computing architecture is a multicore processor.

17. A computing architecture comprising:
a first memory set configured to store a machine learning model with a set of parameters;
a second memory set configured to store a set of fine-tuning parameters for a fine-tuned machine learning model, wherein the fine-tuned machine learning model is a fine-tuned version of the machine learning model that has been fine-tuned to counteract performance degradation of the machine learning model on the computing architecture that is attributable to the first memory set; and
an inference engine configured to generate an inference from the fine-tuned machine learning model using the set of fine-tuning parameters.

18. The computing architecture of claim 17, wherein:
the inference engine uses the set of parameters and the set of fine-tuning parameters to generate the inference from the fine-tuned version of the machine learning model.

19. The computing architecture of claim 17, wherein:
the first memory set includes mask read only memory, and
the second memory set includes an electrically programmable read only memory.

20. The computing architecture of claim 17, wherein:
the set of fine-tuning values forms a low rank adaptation adapter for the machine learning model.

21. The computing architecture of claim 17, wherein:
the set of fine-tuning values replaces a corresponding set of parameters of the machine learning model in the fine-tuned version of the machine learning model.

22. The computing architecture of claim 17, wherein:
the computing architecture is a multicore processor.

23. A computing architecture comprising:
a machine learning model stored in at least one memory;
a fine-tuning portion, for the machine learning model, stored on the computing architecture, wherein the fine-tuning portion counteracts a decrease in performance of the machine learning model on the computing architecture that is attributable to the at least one memory;
an inference engine configured to generate inferences from the machine learning model combined with the fine-tuning portion; and
an automated training routine stored on the computing architecture, wherein the fine-tuning portion is generated by the automated training routine using the machine learning model and the inference engine.
